(19) United States
(12) Patent Application Publication
(10) Pub. No.: US 2013/0152422 A1
(43) Pub. Date: Jun. 20, 2013

(54) DRYER WITH A TEMPERATURE SENSOR AND PROCESS FOR ITS OPERATION

(71) Applicants: Yanhong Chen, Nanjing (CN); Harald Moschütz, Grossbeeren (DE); Vladimir Proseanic, West Bloomfield, MI (US); Svetlana Visnepolschi, West Boomfield, MI (US)

(72) Inventors: Yanhong Chen, Nanjing (CN); Harald Moschütz, Grossbeeren (DE); Vladimir Proseanic, West Bloomfield, MI (US); Svetlana Visnepolschi, West Boomfield, MI (US)

(73) Assignee: BSH HOME APPLIANCES CORPORATION, Irvine, CA (US)

(21) Appl. No.: 13/325,145

(22) Filed: Dec. 14, 2011

(51) Int. Cl. F26B 7/00; D06F 29/00

(52) U.S. Cl. 34/427; 68/20

(57) ABSTRACT

A washer dryer comprising a tub, a drum mounted in the tub to be rotatable around an essentially horizontal axis for receiving laundry items, a process air circuit comprising an air heater and a blower to heat and circulate the heated air through the drum, a heat exchanger to condense moisture from the process air coming out of the drum, and a first temperature sensor in the connecting part between the tub and the heat exchanger, whereby the first temperature sensor is located at a height that is above the lower end of the drum and below the heat exchanger to allow the first temperature sensor to be at least partially immersed in an aqueous liquid contained in the tub when the washer dryer is operated in a washing or rinsing phase. The invention also relates to a method for the operation of this washer dryer.

### BACKGROUND OF THE INVENTION

The present invention relates to a washer dryer with a temperature sensor and a preferred method for its operation. The invention relates in particular to a washer dryer comprising a tub, a drum mounted in the tub to be rotatable around an essentially horizontal axis for receiving laundry items, a process air circuit comprising an air heater and a blower to heat and circulate the heated air through the drum, a heat exchanger to condense moisture from the process air coming out of the drum, and a first temperature sensor in the connecting part between the tub and the heat exchanger, as well as a preferred method for its operation.

Drum washing machines are popular due to their water saving feature and avoidance of damage to laundry processed. In recent years, drum washing machines with a drying function, so-called washer dryers, have become major products in the market. Washer dryers are popular because they combine in a compact manner the functions of a washing machine and a dryer. Moreover, a washer dryer is already provided with a water supply access, such that water is provided not only for the washing of laundry, but also for its further treatment. When drying, such a drum washer dryer takes in air through a fan set on an outside of a tub containing the drum, heats the air with an air heater, and then transfers the heated air to the tub and the inside of the drum. The heated air exchanges heat with the water contained in the laundry and takes away the moisture. The moisture is then condensed in a condensing unit mounted on an outer side of the tub and drained out of the machine.

In general, washing machines with drying functions dry the laundry at substantially constant temperatures and in preset periods of time. Often, however, such method results on the one side in an overdrying of the laundry when the load of laundry to be dried is too small and on the other side in an underdrying of the laundry when the load of laundry is too large. To overcome these disadvantageous effects, it has been known to provide temperature sensors or/and humidity sensors inside the washing machine to detect the temperature or/and humidity. Thus, the degree of dryness can be determined based on the sensor signals. As a result, a drying process can be controlled with relative accuracy.

As an example, document GB 2 082 742 A discloses a dryer which controls the drying time according to the internal temperature change rate in combination with a consideration of the type of clothes being washed and predetermined degree of dryness.

Document CN 1 746 379 A discloses a drum washing machine with a drying function which has an upper temperature sensor and a lower temperature sensor mounted respectively on an upper end and a lower end of a vertical part of a hot air circulating pipe, and which has a control unit that determines a degree of dryness reached, based on the temperature difference detected between the upper and lower temperature sensors, and thereby controls the drying process.

Document CN 1 503 864 A discloses a control unit for detecting the dryness in an air exhaust dryer based on the signals detected by a humidity detection unit and a temperature detection unit. Thereby the drying process can be controlled.

Document CN 1 611 659 A discloses a drum washing machine system control device, which determines the load of the laundry to be dried according to data obtained by a humidity sensor set on a condensing pipe, and a drying device for drum washing machines which adjusts the temperature of a heater based on a laundry load, and a control method for the same.

Document WO 2007/138019 A1 discloses a drum washing machine with a drying program and a control method for the same. The washing machine comprises a tub to hold water; a drum rotatable set in the tub; a heating drying tunnel configured outside said tub; a first temperature detection unit set in the said tub; and a system control unit which controls the drying program based on the signal fed back from the first temperature detection unit.

Documents WO 2009/130145 A1 and US 2011/0030239 A1 disclose a household appliance for drying a laundry item, the household appliance comprising a treatment chamber to receive the laundry item; a closed process air circuit to feed process air through the treatment chamber, the closed process air circuit comprising inter alia: a blower to move the process air; a condenser to condense out moisture carried in the process air; a heater to heat the process air; a first measurement device to determine a temperature of the process air when the process air enters the treatment chamber to provide a first measurement signal; and a controller to control the blower and the heater as a function of the first measurement signal. According to the only FIGURE, a number of temperature sensors on the process air duct or the cooling air duct can be used to control the drying process with redundancy and thus with a particularly high level of stability. For example, a temperature sensor between the tub and the heat exchanger may be used.

The use of a temperature sensor between the tub and the heat exchanger (herein to be referred to as “first temperature sensor”) is thus known in principle. However, the cleaning of the temperature sensor from fluff, also called lint, and inorganic deposits poses a severe problem in that an agglomeration of fluff and inorganic deposits which might even result in limestone may hamper the proper functioning of the washer dryer. It has hence been known to clean this temperature sensor, including an NTC (Negative Temperature Coefficient) sensor, by means of a special rinsing process. This rinsing process consumes however up to 6 liters of water. Such water consumption should be avoided for economic and ecologic reasons.

Fluff accumulation and inorganic deposit formation is of critical significance in washer dryers with an air-air heat exchanger, since much fluff usually accumulates on the heat exchanger. This fluff can disturb the correct temperature measurement of the temperature of the process air and thus the proper functioning of the water dryer. In any event, the present use of temperature sensors and their respective cleaning processes do not ensure a proper cleaning of the temperature sensors, especially over a long service life. In particular, known washer dryers did not allow keeping the temperature sensor between the tub and the air-air heat exchanger clean for a long period up to the whole life of the washer dryer. Another problem that might disturb the proper functioning of the sensor and thus a safe and reliable drying phase is due to the fact that sometimes water drops are splashed against the temperature sensor, causing a wrong temperature measurement.

### SUMMARY OF THE INVENTION

In view of this situation, an object underlying the present invention is the provision of a washer dryer with a temperature sensor in a connecting part between the tub and the heat exchanger which allows a reliable and safe operation of the washer dryer especially during the drying phase, and of a corresponding process for its operation. In particular, the washer dryer should allow that the temperature sensor at the tub outlet and its temperature measurement is more resistant to fluff and condensed water.

In accordance with the present invention, this object is achieved by a washer dryer and a process for its operation with the features of the independent claims. Preferred embodiments of the invention are detailed in the respective dependent claims. Preferred embodiments of the washer dryer correspond to preferred embodiments of the method, even if they are not referred to here in detail.

The invention thus relates to a washer dryer comprising a tub, a drum mounted in the tub to be rotatable around an essentially horizontal axis for receiving laundry items, a process air circuit including an air heater and a blower to heat and circulate the heated air through the drum, a heat exchanger to condense moisture from the process air coming out of the drum. The present invention includes a first temperature sensor located in the connecting part between the tub and the heat exchanger at a height that is above a lower end of the drum and below the heat exchanger, wherein the first temperature sensor is configured to be at least partially immersed in an aqueous liquid contained in the tub when the washer dryer is operated in at least one of a washing phase and a rinsing phase.

The washer dryer of the present invention includes a first temperature sensor located in the connecting part between the tub and the heat exchanger.

The washer dryer may include second or even more temperature sensors to improve its operation. Thus, in a preferred embodiment of the washer dryer, a second temperature sensor is placed in the process air circuit at a location in front of an entrance into the inside of the drum, for example, between the air heater and the sleeve.

In a preferred embodiment of the washer dryer, the first temperature sensor is configured for total immersion in the aqueous liquid when the washer dryer is operated in at least one of a washing phase and a rinsing phase.

Accordingly, fluff and deposits of inorganic salts from a previous drying phase can be removed in a washing or rinsing phase preceding the next drying phase. Thus, the formation of fluff agglomerates or limestone might be avoided. As a result, the first temperature sensor can function properly and the washer dryer of the present invention can function properly.

The present invention is of particular advantage when the first temperature sensor has an elongate body with a temperature sensitive tip. This is for example the case with thermistor based temperature sensors and in particular with NTC temperature sensors which are thus preferred embodiments of the present invention. NTC temperature sensors are particularly preferred since they allow enhancing the accuracy of the temperature determination.

The connecting part between the tub and the heat exchanger can be a part which is integrally formed into the body of the heat exchanger or the tub. Alternatively, it can form a separate piece which is placed between the tub and the heat exchanger. In a particular preferred embodiment, the connecting part is a flexible hose connecting the tub with the heat exchanger.

The first temperature sensor may be situated at various locations within the connecting part. Preferably, the first temperature sensor is located in a lower half of the connecting part. Location in the lower part means here in particular that a tip of the first temperature sensor is at least partially, preferably totally located in the lower half of the connecting part.

In this embodiment, the cleaning of the first temperature sensor in a washing or rinsing phase can be achieved with a lower level of the aqueous liquid in the tub, the connecting part or both. The location in the lower half of the connecting part thus allows placing the connecting part higher than in the case where the first temperature sensor is placed in the upper half of the connecting part without negatively effecting the cleaning process.

In a particularly preferred embodiment of the washer dryer, the first temperature sensor is inclined toward the tub. This allows an even better cleaning of the first temperature sensor. For example, an inclination of the NTC towards the air flow assists movement of water drops on the NTC surface from its top to the bottom. The effect is more pronounced when the first temperature sensor is inclined toward the tub by an angle α in the range of from about 5° to about 30°, more preferably in the range of from about 10° to about 25°, relative to a vertical axis. The term “vertical axis” as used herein refers to an axis that is perpendicular to a ground plate of the washer dryer, the ground level of the room where the washer dryer is to be placed, or both.

Preferably, in the washer dryer of the present invention, the first temperature sensor forms an angle β in the range of from about 25° to about 55°, more preferably from about 35° to about 45°, with a horizontal plane through the center of the connecting part. The horizontal plane is generally perpendicular to the vertical axis mentioned above.

The connecting part preferably includes several folds and the first temperature sensor is preferably placed in or on one of these folds. Preferably, the connecting part is formed from a flexible plastic material.

The washer dryer of the present invention comprises a heat exchanger. In principle, a heat exchanger might be realized by using relatively cold water from the water supply or another source to condense the moisture carried by the process air in a washer dryer. This embodiment can be realized fairly easily, but it consumes rather large amounts of water.

It is thus preferred according to the present invention to use an indirectly cooled condenser, i.e., a condenser in which there is no direct contact between the warm, humid process air to be cooled and the cooling agent used. An indirectly cooled condenser can be realized for example as an air-cooled condenser, i.e. an air-air heat exchanger, with the air serving as the cooling agent being taken usually from the room wherein the washer dryer is placed. The used air is usually fed back to this room after it has been used in the cooling step.

The indirectly cooled condenser may be also embodied as a heat sink of a heat pump in the washer dryer. The heat pump takes in heat from the hot and humid process air in the condenser, pumps this heat to the air heater in the process air circuit and discharges the heat back to the process air. Such a heat pump can be embodied as a compressor heat pump, in which a cooling agent circulates which is cyclically evaporated in the condenser as it absorbs heat from the air flow and condensed in the condenser as it emits heat to the air flow, but the heat pump may also be operating by means of a reversible sorption process, a regenerative gas circuit process or the Peltier effect.

In another preferred embodiment of the present invention, the heat exchanger is an air-air heat exchanger.

In a still further preferred embodiment of the present washer dryer, the first temperature sensor is closer to the tub than to the heat exchanger. This allows the first temperature sensor, for example an NTC temperature sensor, to be assembled close to the moving oscillation system vibrations from the washing and spinning process which provide forces hindering any adhesion at the temperature sensor surface and can assist the removal of water drops.

Preferably, the first temperature sensor is placed in the connecting part in a manner that in can measure the temperature in or close to the center of the process air flow. This allows a more precise control of any drying phase. Thus, the first temperature sensor is preferably arranged such that it may be in contact with the center of the process air flow or the connecting part may be provided with a guiding arrangement that guides the process air flow towards the first temperature sensor.

In the case of an indirectly cooled condenser, the washer dryer of the present invention can contain a rinsing device for the condenser, which cleans the heat exchanger. In such an embodiment, the rinsing device can be used to additionally clean the first temperature sensor. To this end the rinsing device may be connected to a water supply of the washer dryer.

In general a washer dryer is connected to a water supply system which allows guiding water through a detergent rinsing device such that portions of detergent or auxiliaries can be flushed into the tub. Such a water supply system may comprise a bifurcation to the heat exchanger such that water from the water supply system may be used for the rinsing device of the heat exchanger, as cooling liquid itself in the heat exchanger, or both.

A washer dryer generally includes a suds discharge system at its base, the suds discharge system including a drain valve and a suds pump and any necessary pipes. Further, a washer dryer in general contains laundry agitators, scooping devices, or both. It is apparent that a plurality of such laundry agitators and/or scooping devices, in particular a number of three or four, is preferred. A laundry agitator may be cast into the drum as an integral component or inserted into the drum as an additional component. It is also representative of a plurality of embodiments for the structural configuration, which is in particular also conceivable as an arrangement of particular fins or as a helical wound configuration of an interior part of the drum.

A washer dryer generally has switching means for rotating and stopping the drum. Moreover, a washer dryer according to the present invention preferably comprises a sensor for determining a quantity of liquid disposed in the suds container. The sensor is usually placed in a lower part of the tub. A conventional sensor for determining the water level can be used as a sensor for determining the quantity of liquid disposed in the tub, i.e. the suds container, the sensor signal of which is tracked during the process. Such a sensor generally measures a hydrostatic pressure p and/or a temporal gradient (Δp/Δt)₁ of the hydrostatic pressure p.

In addition, a washer dryer in general contains a heater for the direct heating of an aqueous liquid, for example suds. This heater, termed herein “water heating”, is in general disposed in the tub below the drum.

The invention is moreover directed to a method for operating a washer dryer comprising a tub, a drum mounted in the tub to be rotatable around an essentially horizontal axis for receiving laundry items, a process air circuit comprising an air heater and a blower to heat and circulate the heated air through the tub, a heat exchanger to condense moisture from the process air coming out of the drum, and a first temperature sensor in the connecting part between the tub and the heat exchanger, whereby the first temperature sensor is located at a height that is above the lower end of the drum and below the heat exchanger, the method including the step of conducting at least one of a washing phase and a rinsing phase wherein a first temperature sensor disposed between the lower end of the drum and the heat exchanger is at least partially immersed in an aqueous liquid contained in the tub.

In a preferred embodiment, this method is conducted under forced convection to increase flow around the first temperature sensor. Forced convection that results in an increased turbulent flow around the first temperature sensor can be established by a specific rotation pattern of the drum such that the aqueous liquid in the tub is pushed toward, preferably back and forth, the first temperature sensor in the connecting part. As an alternative or in addition thereto, the blower of the washer dryer may be used to create a strong air flow which impinges on the aqueous liquid and thus creates forced convection.

A specific cleaning phase can be defined within a washing or rinsing phase that is optimized to clean the first temperature sensor.

Cleaning can be preferably carried out in a wash or rinse phase where an imbalance in the load distribution gives rise to vibrations of the drum and the tub, respectively. This assists in the removal of fluff or inorganic deposits.

In a preferred process of the present invention, a drying phase is conducted by controlling the blower and the air heater such that a set maximum temperature Tₘₐₓ for the temperature of the process air is not exceeded.

The invention has numerous advantages. The washer dryer of the present invention operates with a first temperature sensor that is protected against disturbing effects caused by water drops and fluff. Namely, the first temperature sensor is placed in a manner such that it can be cleaned from deposits of fluff or inorganic salts during at least one of washing phase and a rinsing phase of the washer dryer. Thus, in the washer dryer of the present invention, the temperature sensor provides highly reliable signals regarding the temperature of the process air leaving the drum and the tub. As a result, the operation of the washer dryer can be controlled precisely. The risk of an overheating of the laundry items to be dried can be avoided. This is of particular advantage when sensitive laundry items are being dried. The protection of sensitive laundry items such as wool, silk or lace during a drying phase is thus significantly improved.

Fluff accumulated on the first temperature sensor can be removed efficiently in a washing or rinsing process preceding the drying phase. Thus, for controlling the drying phase a freshly cleaned first temperature sensor can be used. As a result, the washer dryer of the present invention allows precise and safe drying phases. These advantages can be achieved without an increased water level and without additional water consumption. The water dryer can thus be operated safely without using large amounts of water.

The washer dryer of the present invention provides a temperature sensor between the tub and a heat exchanger that will not be affected by condensed water resulting from the heat exchange involving the heat exchanger.

In specific embodiments of the invention, especially with NTC temperature sensors having a long body and the heat sensitive element at its tip, the effect of water drops is further reduced in that any water drop on its surface will run to the bottom and will not evaporate on the tip of the sensor.

### BRIEF DESCRIPTION OF THE DRAWINGS

FIG. 1 is a diagrammatic section view of a washer dryer according to a preferred embodiment of the present invention;

FIG. 2 is a partial section view of a connecting hose between the tub and the heat exchanger; and

FIG. 3 is an end-on section view of a connecting part as illustrated in FIG. 2, showing optional positions for the first temperature sensor.

### DETAILED DESCRIPTION OF EXEMPLARY EMBODIMENTS OF THE PRESENT INVENTION

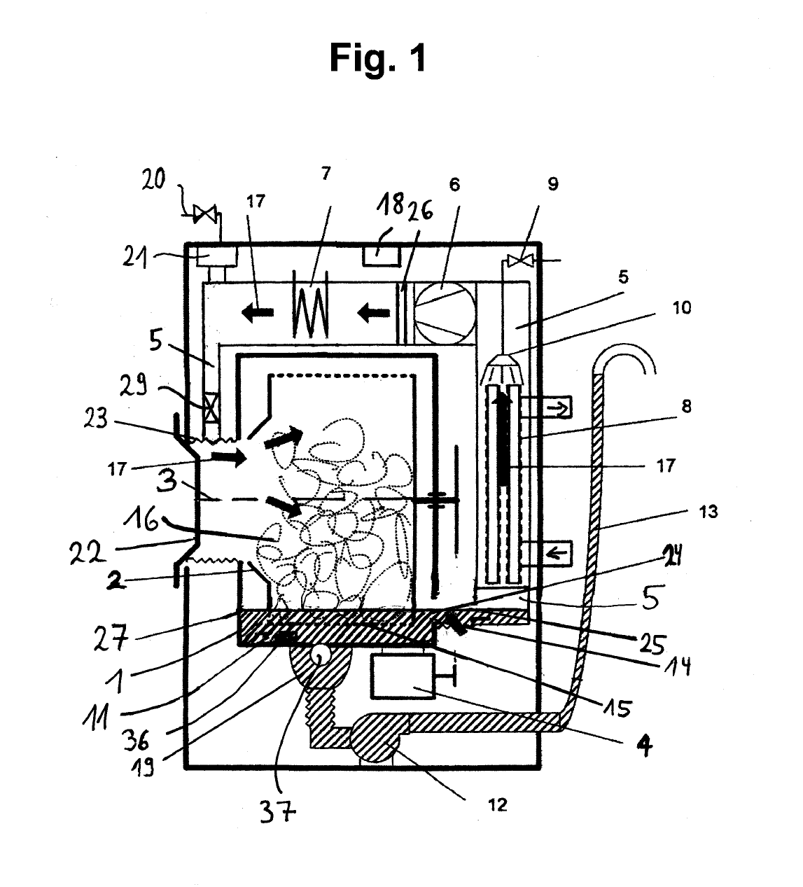

Turning now to the drawings and, more particularly to FIG. 1, a washer dryer according to one embodiment of the present invention configured for carrying out the method of the present invention is illustrated. Other embodiments are conceivable.

According to one preferred embodiment, the present washer dryer includes a tub 1 and a drum 2 which is placed in the tub 1 such that it can be rotated around a generally horizontal axis 3. Laundry items 16 to be treated are placed in the drum 2. The tub 1 is connected to a heat exchanger 8 by means of a flexible hose 25 used as a connecting part. The heat exchanger 8 is an air-air heat exchanger.

The tub is connected via a suds draining duct 19 to a pump 12 which acts to discharge an aqueous liquid 11, for example suds, out of the tub 1 and via a drain pipe 13 out of the washer dryer. The drum 2 is driven by a drive motor 4.

The drum 2 is filled through a door 22 that allows access to the interior of the drum for placement of laundry 16 items to be treated in the drum 2. In order to wash laundry in the washer dryer, the washer dryer is connected to a water feed line 20. The water feed line 20 is connected to a detergent rinsing device 21 from which detergent and auxiliary agents can be flushed with the aid of water from the water feed line 20 into the tub 1. This is achieved in this embodiment through a part of the process air circuit 5 and a sleeve 23.

For drying wet laundry items in the drum 2 of the washer dryer of FIG. 1 which operates according to the principle of circulating air, the air heated by the air heater 7 (“process air”) is driven through the process air circuit 5 with the aid of a blower 6. Thus, heated process air enters the tub 1 and the drum 2, respectively, through the sleeve 23. After having passed the drum 2 and having taken up humidity from the wet laundry items 16, the humid and warm process air arrives at a rear exit 24 of the tub 1 and thereafter at the heat exchanger 8, where the humidity contained in the process air condenses as a result of the cooling with cold air in the air-air heat exchanger 8. The condensate may be collected in a condensate container (not shown here) or may flow back to the tub 1 and finally to the suds draining duct 19 to be disposed through the drain pipe 13. The dried air continues to flow inside the process air circuit 5 to be heated again by means of the air heater 7 and to be led again via the sleeve 23 into the drum 2. Filled arrows 17 indicate the flow of the warm air. Short unfilled arrows indicate the flow of the cooling air inside the air-air heat exchanger 8.

In the flexible hose 25, a first temperature sensor 14 is placed such that the first temperature sensor 14 is located at a height 27 that is above the lower end 15 of the drum 2 and below the heat exchanger 8 to allow the first temperature sensor 14 to be at least partially immersed in an aqueous liquid 11 contained in the tub 1 when the washer dryer is operated in a washing or rinsing phase. As can be seen from FIG. 1, the height 27 is such that the aqueous liquid 11 is at the same height as the tip of the first temperature sensor 14. Thus, the first temperature sensor 14 can be immersed totally in the aqueous liquid 11 during a washing or rinsing phase.

In the embodiment of the washer dryer shown in FIG. 1, the first temperature sensor 14 is placed in the lower part of the flexible hose 25. Moreover, the first temperature sensor 14 is inclined toward the tub 1.

In order to allow a more precise control of a drying phase in the washer dryer, a second temperature sensor 29 is placed in the process air circuit 5 close to the door 22.

The washer dryer of FIG. 1 allows a method for its operation whereby a washing or rinsing phase involving an aqueous liquid 11 is conducted such that the first temperature sensor 14 is at least partially immersed in the aqueous liquid 11. Moreover, the washer dryer allows conducting the process under forced convection to increase flow around the first temperature sensor 14. This can be achieved by employing the blower 7 also during a washing or rinsing phase such that a strong flow of air is made to impinge on the aqueous liquid 11 in the tub 1 which is then driven in the direction of the first temperature sensor 14.

A drying phase is usually carried out by circulating process air repeatedly through the process air circuit until a desired degree of dryness in the laundry items is obtained. The washer dryer of FIG. 1 allows a precise control of the drying phase in that the drying phase is conducted by controlling the blower 6 and the air heater 7 such that a set maximum temperature Tₘₐₓ for the temperature of the process air is not exceeded.

A sensor 36 for measuring the hydrostatic pressure p in the suds container 1 is also provided.

The washer dryer of the embodiment of FIG. 1 has a rinsing device 10 for the heat exchanger 8 which can be connected by means of a water valve 9 to a water supply system, for example the water feed line 20.

FIG. 1 shows also a control unit 18 which controls the operation of the washer dryer based on, inter alia, the signals received from the first and second temperature sensors. The water valve 9, the air heater 7 and the water heater 37 are controlled by the control unit 18 as a function of a program workflow, which is associated with a time program and/or with the achievement of certain measured values of parameters such as the level of an aqueous liquid, for example the suds level, suds temperature and the speed of the drum 2.

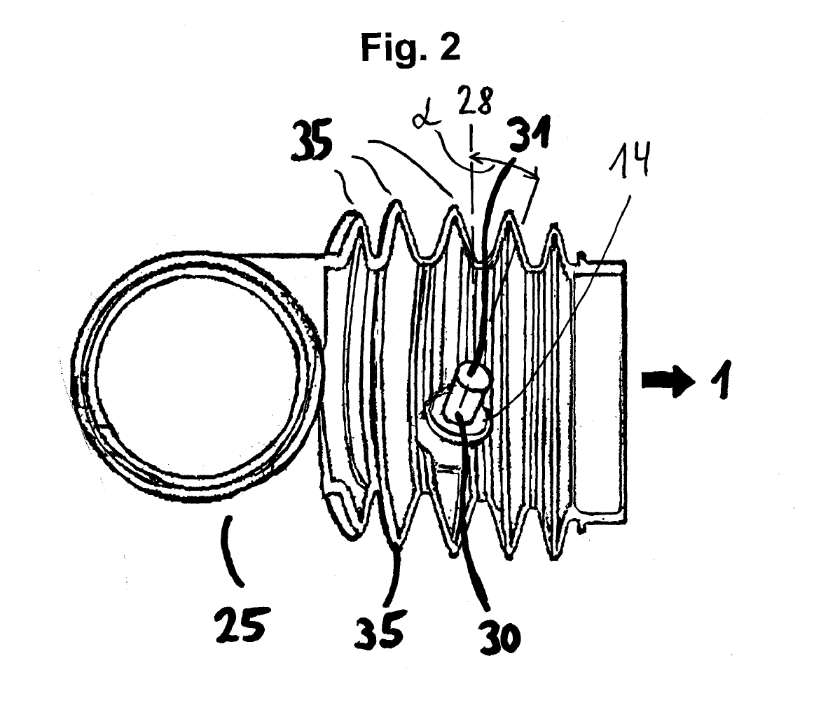

FIG. 2 shows an enlarged view of the connecting part between the tub and the heat exchanger. In particular, a cut through a hose is shown such that the interior of the hose can be seen.

The first temperature sensor 14 shown herein is an NTC temperature sensor with an elongate body 30 and a temperature sensitive tip 31. The first temperature sensor 14 is located on a fold 35 in a lower half of the thus flexible hose 25. The first temperature sensor 14 is declined in the direction of the tub which is not shown here. However, an arrow indicates the direction to the tub 1.

The first temperature sensor 14 is here inclined towards the tub 1 by an angle α in the range of from about 5° to about 30°, relative to a vertical axis 28.

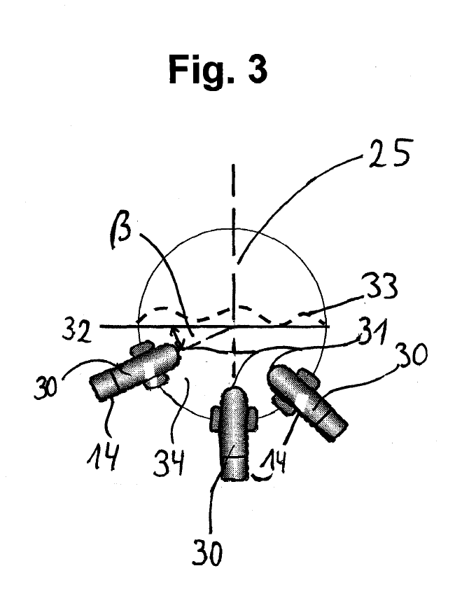

FIG. 3 shows a cut through a connecting part similar to the one shown in FIG. 2 with different positions for the first temperature sensor.

The first temperature sensor 14 is in each case in the lower half 34 of the connecting part. The first temperature sensor 14 shown herein is an NTC temperature sensor with an elongate body 30 and a temperature sensitive tip 31.

In FIG. 3, the first temperature sensor 14 forms an angle β in the range of from 0 to about 70° with a horizontal plane 32 through the center of the connecting part 25. Two particular preferred locations for the first temperature sensor 14 are shown wherein the angle β is in the range of from about 25° to about 55°.

The surface 33 of an aqueous liquid in the connecting part 25 shown here illustrates that the first temperature sensor 14 can be totally immersed in an aqueous liquid during a washing or rinsing phase.

It will therefore be readily understood by those persons skilled in the art that the present invention is susceptible of a broad utility and application. While the present invention is described in all currently foreseeable embodiments, there may be other, unforeseeable embodiments and adaptations of the present invention, as well as variations, modifications and equivalent arrangements, that do not depart from the substance or scope of the present invention. The foregoing disclosure is not intended or to be construed to limit the present invention or otherwise to exclude such other embodiments, adaptations, variations, modifications and equivalent arrangements, the present invention being limited only by the claims appended hereto and the equivalents thereof.

What is claimed is:

1. A washer dryer having a tub; a drum mounted in the tub to be rotatable around a generally horizontal axis for receiving laundry items; a process air circuit including an air heater and a blower to heat and circulate the heated air through the drum; a heat exchanger to condense moisture from the process air coming out of the drum; the washer dryer comprising a first temperature sensor disposed in a connecting part between the tub and the heat exchanger at a height between the lower end of the drum and the heat exchanger, wherein the first temperature sensor is configured to be at least partially immersed in an aqueous liquid contained in the tub when the washer dryer is operated in at least one of a washing phase and a rinsing phase.

2. A washer dryer according to claim 1 wherein the first temperature sensor is configured to be completely immersed in the aqueous liquid when the washer dryer is operated in at least one of a washing phase and a rinsing phase.

3. A washer dryer according to claim 1 wherein the first temperature sensor has an elongate body with a temperature sensitive tip.

4. A washer dryer according to claim 1 wherein the first temperature sensor is an NTC temperature sensor.

5. A washer dryer according claim 1 wherein the connecting part is formed as a flexible hose connecting the tub with the heat exchanger.

6. A washer dryer according to claim 1 wherein the first temperature sensor is disposed in a lower half of the connecting part.

7. A washer dryer according claim 1 wherein the first temperature sensor is inclined toward the tub.

8. A washer dryer according to claim 7, wherein the first temperature sensor is inclined toward the tub by an angle α in the range of from about 5° to about 30°, relative to a vertical axis.

9. A washer dryer according claim 1 wherein the first temperature sensor forms an angle β in the range of from about 25° to about 55°, relative to a horizontal plane through the center of the connecting part.

10. A washer dryer according to claim 1 wherein the connecting part includes a plurality of folds and the first temperature sensor is disposed in one of these folds.

11. A washer dryer according to claim 1 wherein the heat-exchanger is an air-air heat exchanger.

12. Washer dryer according to claim 1 wherein the first temperature sensor is closer to the tub than to the heat exchanger.

13. A method for operating a washer dryer, the washer dryer having a tub; a drum mounted in the tub to be rotatable around an essentially horizontal axis for receiving laundry items; a process air circuit comprising an air heater and a blower to heat and circulate the heated air through the drum; a heat exchanger to condense moisture from the process air coming out of the drum; and a first temperature sensor in the connecting part between the tub and the heat exchanger, the method comprising the step of conducting at least one of a washing phase and a rinsing phase wherein a first temperature sensor disposed between the lower end of the drum and the heat exchanger is at least partially immersed in an aqueous liquid contained in the tub.

14. The method according to claim 13 wherein at least one of a washing phase and a rinsing phase is conducted under forced convection to increase flow around the first temperature sensor.

15. The method according to claim 13 and further comprising the step of conducting a drying phase by controlling the blower and the air heater wherein a set maximum temperature Tₘₐₓ for the temperature of the process air is not exceeded.
